(19) United States
(12) Patent Application Publication
(10) Pub. No.: US 2008/0226859 A1
(43) Pub. Date: Sep. 18, 2008

(54) Flotation objects for outdoor ponds

(76) Inventors: Paul Christiensen Manning, Logan, UT (US); Salam M. Awada, Logan, UT (US); Rex S. Spendlove, Millville, UT (US)

Correspondence Address: KEELY SCHNEITER, 399 NORTH MAIN, SUITE 300, LOGAN, UT, 84321, US

(21) Appl. No.: 11/716,853

(22) Filed: Mar. 12, 2007

(51) Int. Cl. B32B 3/02; C08F 114/06; C08F 220/44

(52) U.S. Cl. 428/53; 428/66.5; 526/342; 526/344.3

(57) ABSTRACT

A flotation object floats on the surface of outdoor ponds and other bodies of water. The flotation object includes a circular middle portion and first and second hexagonal end portions. When the flotation objects are placed in a pond the objects contact each other in such a way that the flotation objects substantially interlock.

### BACKGROUND OF THE INVENTION

1. The Field of the Invention

This invention relates generally to products made for use with outdoor ponds. More specifically, embodiments of the present invention assist in the maintenance, protection, and concealment of outdoor ponds.

2. Related Technology

Outdoor ponds or lagoons are used in a wide variety of industries for numerous purposes. For examples, use of outdoor ponds or lagoons is standard practice is industries ranging from mining, transportation, and municipal treatment, to golf courses. In fact, many industries that produce tailings use outdoor ponds or lagoons to store and/or treat the tailings produced.

While outdoor ponds can be extremely useful in their application, certain problems may arise. Particularly, birds, bats, and other wildlife may land in or glide through outdoor ponds. While in some instances the presence of the wildlife may be annoying, in other instances the wildlife may be dangerously exposed to toxic substances present in the outdoor ponds.

In order to prevent wildlife from contacting the outdoor ponds many pond-covering methods have been developed. For example, steel nets can be placed over a pond to inhibit birds from landing on the surface of the pond. Unfortunately, covering methods such as steel nets are difficult to put in place and often, because of their rigid shape, do not adequately cover the entire pond surface.

Another pond-protection method involves covering the pond with small balls, usually made of plastic. The balls float on the surface of the pond, with enough balls placed upon the pond to cover the entire pond surface. For ponds having a curved or non-uniform shape, the balls are able to conform to the shape of the pond and still cover the entire surface. Thus, wildlife is prevented from contacting the pond surface and the pond surface is covered, regardless of the shape of the pond.

Although these pond-protection balls are an improvement over other methods for covering outdoor ponds, there are still shortcomings in the design of such balls. For example, the shape of many pond-protection balls is such that even when the balls are packed closely in a pond, gaps are present between adjacent balls. Such gaps can decrease heat retention in ponds, and can also contribute to algal growth by allowing sunlight to reach the surface of the ponds.

What is needed are products to cover ponds that are able to maximize the surface area of the pond that is completely covered.

### BRIEF SUMMARY OF THE INVENTION

A flotation object, which floats on the surface of an outdoor pond has a circular middle portion and two symmetric hexagonal end portions. When flotation objects are placed in a pond the objects fit closely together and substantially interlock. Substantially the entire surface of an outdoor pond is covered by the flotation objects, thus the pond is protected from wildlife and providing other benefits.

These and other aspects of the present invention will become more fully apparent from the following description and appended claims, or may be learned by the practice of the invention as set forth hereinafter.

### BRIEF DESCRIPTION OF THE DRAWINGS

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings are not drawn to scale. The invention will be described and explained with additional specificity and detail through the use of the accompanying drawings in which:

FIG. 1 shows a flotation object;

FIG. 2 shows a configuration of four flotation objects with a view look down on the surface of a pond where the flotation objects have been placed; and

FIG. 3 shows a configuration of numerous flotation objects.

### DETAILED DESCRIPTION OF THE PREFERRED EMBODIMENTS

Embodiments of the present invention include flotation objects for use on outdoor ponds, lagoons, and other bodies of water. The shape of the flotation objects allows each object to substantially interlock with adjacent flotation objects, thus forming a substantially interlocking cover for an outdoor pond. The flotation objects are able to substantially cover the entire surface of the pond, thereby providing many benefits such as, for example, preventing birds and other wildlife from contacting the surface of or landing on the pond, preventing algae growth within the pond, enhancing heat retention in the pond, reducing evaporation from the pond, reducing foul smell that may be emitting from the pond, and so forth. Other benefit offered by embodiments of the present invention include, for example, allowing rainwater to pass through the flotation objects and into the pond.

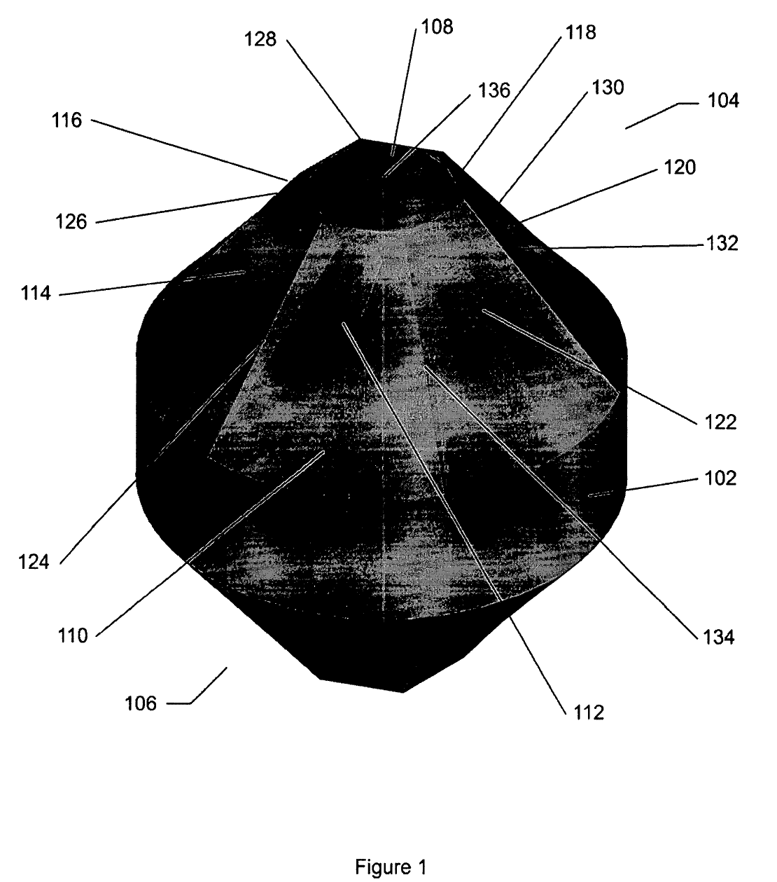

With attention now to FIG. 1, an outline drawing of a flotation object 100 is shown. In one embodiment of the invention, flotation object 100 is made of plastic, such as, for example, high-density polyethylene (HDPE), polyvinyl chloride (PVC), acrylonitrile butadiene styrene (ABS), low-density plastic, recycled plastics, or any other plastic. Flotation object 100 is buoyant, or in other words, flotation object 100 floats. Further, in one embodiment of the invention flotation object 100 is resistant to ultraviolet radiation. Finally, flotation object 100 may be any color or combination of colors, such as, for example, black, brown, blue, green, yellow, orange, or clear.

The flotation object 100, or flotation ball, or hexi-ball, includes a circular middle portion 102. Flotation object 100 further includes a first hexagonal end portion 104 and a second hexagonal end portion 106, each of which is connected to circular middle portion 102. In one embodiment of the invention, the width of circular middle portion 102 is less than the width of each of first hexagonal end portion 104 and second hexagonal end portion 106. Moreover, first hexagonal end portion 104 and second hexagonal end portion 106 are substantially symmetric.

Each of first hexagonal end portion 104 and 106 includes a hexagon end piece 108 and a side portion 110, with side portion 110 further including side walls 112, 114, 116, 118, 120, and 122. Where adjacent side walls 112, 114, 116, 118, 120, and 122 meet, ridges 124, 126, 128, 130, 132, and 134 are present. Each of ridges 124, 126, 128, 130, 132, and 134 extends from a vertex of hexagon end piece 108. In one embodiment of the invention hexagon end piece 108 of first hexagonal end portion 104 includes a small hole 136. Flotation object 100 ranges in size from 1 inch to 12 inches, measuring from hexagon end piece of end portion 104 to hexagon end piece 108 of end portion 106. In one embodiment of the invention the size of flotation object 100 is 1 inch to 4 inches.

After flotation object 100 has been fabricated and is still warm flotation object 100 may be placed into a cooling bath. In one embodiment of the invention, therefore, flotation object 100 may be partially filled with water (not shown). Finally, small hole 136 may be sealed with a sealant, such as, for example, a silicone based sealant. In another embodiment of the invention the small hole 136 is heat sealed.

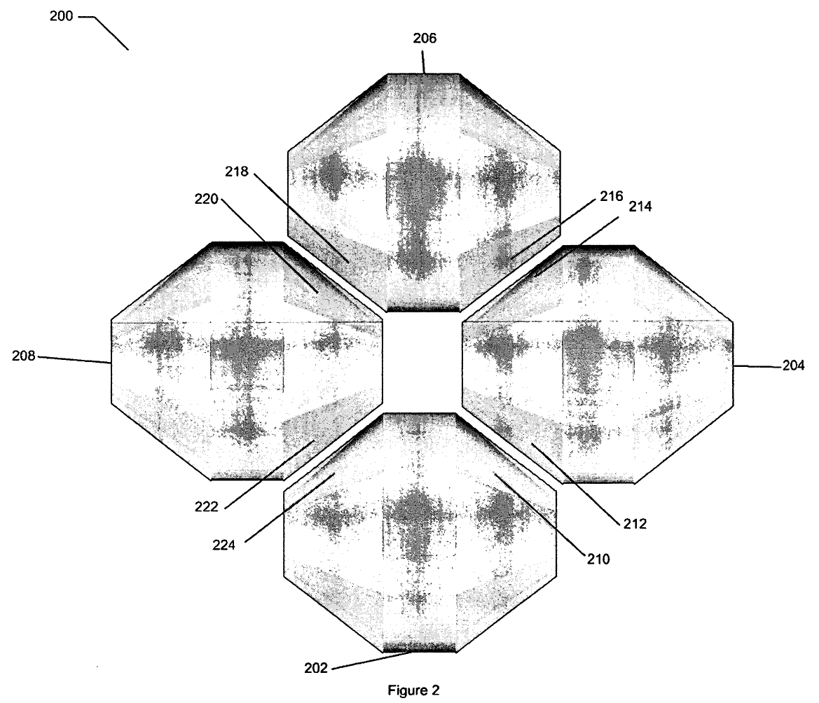

With attention now to FIG. 2, one embodiment of a configuration 200 of multiple flotation objects 202, 204, 206, and 208, with a view looking down on the surface of a body of water, is shown. Hexagonal end portion 210 of flotation object 202 and hexagonal end portion 212 of flotation object 204 are substantially aligned and, in one embodiment of the invention, hexagonal end portions 210 and 212 are in contact (not shown). In other words, when hexagonal end portions 210 and 212 contact each other hexagonal end portions 210 and 212 fit together. Likewise, hexagonal end portions 214 and 216 fit together, hexagonal end portions 218 and 220 fit together, and hexagonal end portion 222 and 224 fit together. Thus, each of flotation objects 202, 204, 206, and 208 fits together with the flotation objects adjacent to it. It is to be appreciated that the configuration 200 shown in FIG. 2 is one example of how flotation objects 202, 204, 206 and 208 may fit together. Other embodiments of the invention include any number of additional configurations of flotation objects 202, 204, 206, and 208.

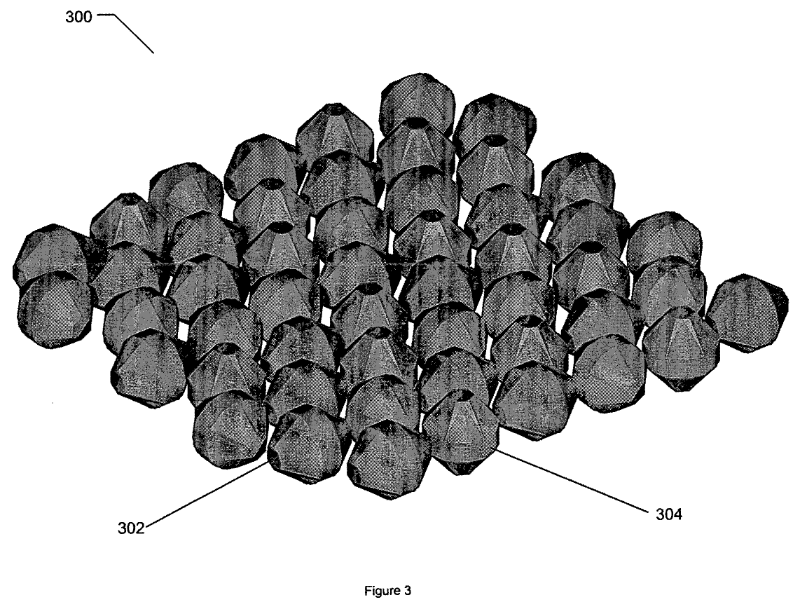

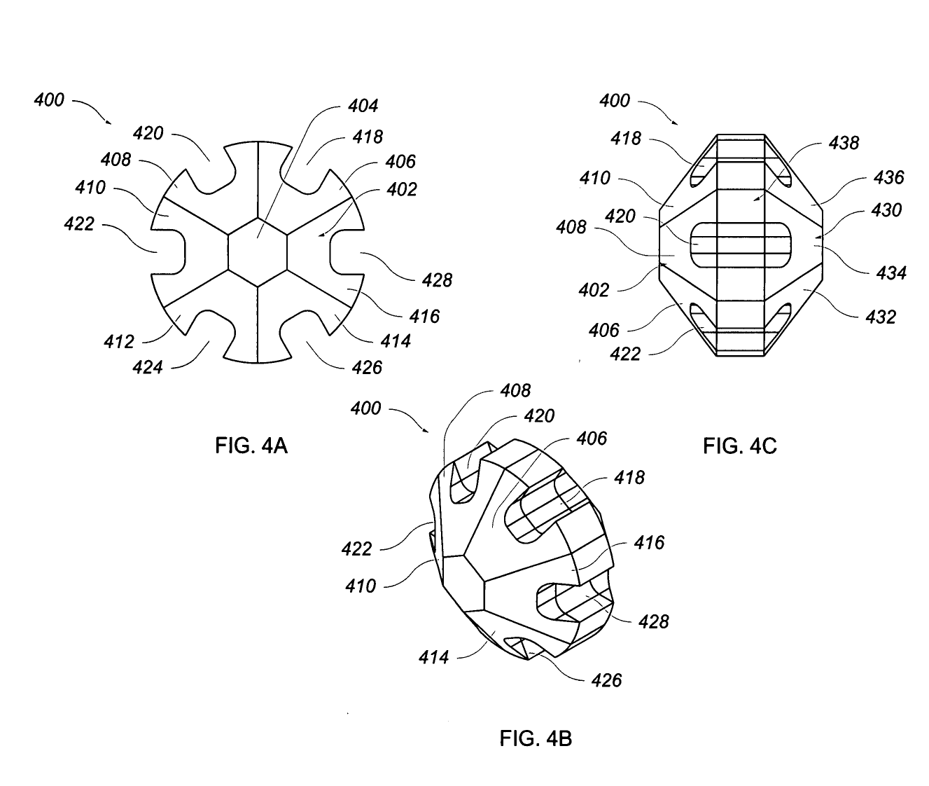

With attention now the FIG. 3, a random configuration 300 of numerous flotation objects placed on the surface of an outdoor pond is shown. When the flotation objects are placed in the pond the flotation objects may assume any number of configurations. Each flotation object may be oriented sideways, as shown by object 302, or lengthways, as shown by object 304. While the random configuration 300 includes flotation objects oriented both sideways and lengthways, the flotation objects fit together closely to substantially cover the surface of an outdoor pond.

When an entire body of water is covered in flotation objects, the flotation objects interlock as described above to substantially cover the entire surface of the water. The unique shape of the flotation objects allows the flotation objects to fit together more closely than flotation objects of other shapes. Thus, flotation objects as described in embodiments of the present invention provide a covering for outdoor ponds and other bodies of water that protects ponds from wildlife, contributes to heat retention, contributes to decreased algae growth, and provides numerous other benefits, including, for example, allowing rainwater to permeate the layer of flotation objects and enter the pond. Moreover, embodiments of the present invention also include flotation objects of a variety of colors and combinations of colors, thus contributing to the aesthetics of the layer of flotation objects covering an outdoor pond.

The present invention may be embodied in other specific forms without departing from its essential characteristics. The embodiments described above are to be considered in all respects only as representative and not restrictive. The scope of the invention is, therefore, indicated by the following claims rather than by the preceding description. All changes which come within the meaning and range of equivalency of the claims are to be embraced within their scope.

1. A flotation object suitable for use in outdoor ponds, comprising:
a circular middle portion;
a first and a second hexagonal end portion, wherein each of the first and the second hexagonal end portions includes a hexagon end piece and a side portion extending from the hexagon end piece to the circular middle portion.

2. The flotation object as recited in claim 1:
wherein the side portion includes six walls, each of the six walls extending from a side of the hexagon end piece to the circular middle portion;
six ridges, each of the six ridges being formed where two adjacent walls of the six walls meet; and
each of the six ridges extend from a vertex of the hexagon end piece.

3. The flotation object as recited in claim 1:
wherein the first hexagonal end portion and the second hexagonal end portion are substantially symmetric.

4. The flotation object as recited in claim 1:
wherein a width of the circular middle portion is less than a width of each of the first and second hexagonal end portions.

5. The flotation object as recited in claim 1:
wherein one of the first and second hexagonal end portions of a first flotation object interlock with one of the first and second hexagonal end portions of a second flotation object.

6. The flotation object as recited in claim 1 substantially comprising one or more of: high-density polyethylene (HDPE); polyvinyl chloride (PVC); acrylonitrile butadiene styrene (ABS); low-density plastic; or, any other material.

7. The flotation object as recited in claim 6 wherein the material is resistant to ultraviolet radiation.

8. The flotation object as recited in claim 1 wherein the flotation object is: black; green; blue; brown; yellow; orange; or, any other color or combination of colors.

9. The flotation object as recited in claim 1, wherein the hexagon end piece of one of the first and second hexagonal end portions includes a hole.

10. The flotation object as recited in claim 9, wherein the hole is sealed.

11. The flotation object as recited in claim 1, wherein the flotation object is partially filled with water.

12. The flotation object as recited in claim 1, wherein the flotation object substantially floats on the surface of a body of water.

13. The flotation object as recited in claim 1, wherein the size of the flotation object ranges from 1 inch to 12 inches.

14. A flotation ball, comprising:
first and second symmetrical end portions joined at a circular middle portion, each of the first and second symmetrical end portions including a hexagon end piece and a hexagonal side portion;
the hexagon end piece being located at the end of each of the first and second symmetrical end portions; and
the hexagonal side portions including six wall portions extending from each of the six sides of the hexagon end piece to the circular middle portion.

15. The flotation ball as recited in claim 14, further comprising:
six ridges, wherein each of the six ridges is located at a joining of two adjacent wall portions of the six wall portions; and
each of the six ridges extending from a vertex of the hexagon end piece.

16. The flotation ball as recited in claim 14:
wherein a width of the circular middle portion is less than a width of the first hexagonal end portion and less than a width of the second hexagonal end portion.

17. The flotation ball as recited in claim 14:
wherein one of the first and second hexagonal end portions of a first flotation ball substantially interlocks with one of the first and second hexagonal end portions of a second flotation ball.

18. The flotation ball as recited in claim 14 substantially comprising one or more of: acrylonitrile butadiene styrene (ABS); high-density polyethylene (HDPE); polyvinyl chloride (PVC); low-density plastic; or, any other material.

19. The flotation ball as recited in claim 18 wherein the flotation ball is resistant to ultraviolet radiation.

20. The flotation ball as recited in claim 14, wherein the flotation ball is one of: black; brown; green; blue; yellow; orange; or, any other color or combination of colors.

21. Flotation objects for use on bodies of water, comprising:
a circular middle portion;
a first and a second hexagonal end portion, wherein each of the first and the second hexagonal end portions includes a hexagon end piece and a side portion extending from the hexagon end piece to the circular middle portion.

22. Flotation objects as recited in claim 21:
wherein the side portion includes six walls, each of the six walls extending from a side of the hexagon end piece to the circular middle portion;
six ridges, each of the six ridges being formed where two adjacent walls of the six walls meet; and
each of the six ridges extend from a vertex of the hexagon end piece.

23. Flotation objects as recited in claim 21:
wherein the first hexagonal end portion and the second hexagonal end portion are substantially symmetric, with an axis of symmetry defined as an axis of symmetry perpendicular to a central axis, wherein the central axis extends through the center of each of the hexagon end portions, with the axis of symmetry further extending through a center of the circular middle portion.

24. Flotation objects as recited in claim 21:
wherein a width of the circular middle portion is less than a width of each of the first and second hexagonal end portions.

25. Flotation objects as recited in claim 21, wherein two or more flotation objects substantially interlock.

26. Flotation objects as recited in claim 25, wherein the substantially interlocking flotation objects substantially cover a surface of an outdoor body of water.

27. The object as recited in claim 1, further comprising at least one opening.

28. The object as recited in claim 27, wherein the at least one opening extends through the circular middle portion.

29. The flotation ball as recited in claim 14, further comprising at least one opening extending from the first symmetrical end portion through the circular middle portion to the second symmetrical end portion.

30. The flotation objects as recited in claim 21, further comprising at least one opening extending through the circular middle portion.
